(19) United States
(12) Patent Application Publication
(10) Pub. No.: US 2012/0201623 A1
(43) Pub. Date: Aug. 9, 2012

(54) METHOD AND APPARATUS FOR NON-ROTARY MACHINING

(75) Inventors: William Q. Tingley, III, Grand Rapids, MI (US); William Q. Tingley, Grand Rapids, MI (US); Daniel R. Bradley, Grand Rapids, MI (US)

(73) Assignee: TENNINE CORP., Grand Rapids, MI (US)

(21) Appl. No.: 13/426,266

(22) Filed: Mar. 21, 2012

Related U.S. Application Data
(63) Continuation-in-part of application No. 12/520,785, filed on Dec. 7, 2009, now abandoned.

(51) Int. Cl. B23D 5/00; B23D 7/08

(52) U.S. Cl. 409/293; 409/317

(57) ABSTRACT

A non-rotary shaping method (700, 800, 900) and shaping center (600) for forming a part using a non-rotating cutting tool (400) for removing material from a non-rotating workpiece within a three-dimensional work envelope that obsoletes the use of mills for profiling operations. Without the need to rotate to produce sufficient surface footage to remove material, the cutting tool (400) applies constant cutting force to the workpiece along a one-, two-, or three-dimensional cutting path at a sufficiently high feed rate to remove material by means of controlled fracturing instead of plastic deformation. Also, without the need to rotate, neither the cutting tool nor the part are constrained in shape by axial symmetrical. Therefore, parts without any restriction in shape can be produced with finer surface finishes and higher material removal rates than by milling.

### CROSS-REFERENCE TO RELATED APPLICATION

This application claims priority under 35 U.S.C. §120 and is a continuation-in-part of U.S. patent application Ser. No. 12/520,785, filed on Dec. 7, 2009, entitled “METHOD AND APPARATUS FOR NON-ROTARY MACHINING.” The aforementioned related application is hereby incorporated by reference in its entirety.

### FIELD OF THE INVENTION

This invention relates generally to methods and tools for machining parts and, more particularly, to machines that are capable of performing profiling operations.

### BACKGROUND

There are two basic machining operations that are well known in the art. These might be broadly categorized as “profiling” where material is removed from a workpiece to produce a specified shape and surface finish and “holemaking” where material is removed from a workpiece to produce a drilled, tapped, or counterbored hole. With regard to profiling, in order to profile a workpiece, there are three basic processes for removing material from a workpiece viz. deformation, electrolysis and ablation. Deformation is a process where a cutting tool removes material from a workpiece by direct contact. This process is the least restricted in the shapes and materials that can be cut by the cutting tool. The “turning” and “milling” processes are the most common examples of deformation. Electrolysis is a process where a cathode electrochemically dissolves material from an anodized workpiece. This process is restricted to electrically conductive materials. Electrochemical and electrical discharge machining are examples of electrolysis. Finally, ablation is a process where a beam of energy vaporizes or erodes material from a workpiece. The ablation process is limited to flat work that lacks the requirement for three-dimensional features. Laser and water-jet cutting are examples of the ablation process.

In order to remove material by deformation, or sometimes called “contact machining”, there are two basic mechanisms. The first is rotary motion in which either the cutting tool or the workpiece is fixtured to a spindle and rotated to provide sufficient force to remove material. In turning, the workpiece rotates as the cutting tool moves through it. Similarly in a milling process, the cutting tool rotates as it moves through the workpiece. The second is non-rotary motion in which neither the cutting tool nor the workpiece rotates and the force of the linear motion of the tool relative to the workpiece is sufficient to remove material. shaping, planning, and broaching are examples of non-rotary machining techniques using deformation.

Prior art systems such as Japanese Patent 63-123603 assigned to Mitsubishi Heavy Industry K.K. describes a rotating milling machine with an “add on” adapter design that is capable of machining materials with only finish type cut surfaces. However, the Mitsubishi patent is not capable of rough or intermediate type machining operations that would be used for removing large amounts of material from a workpiece in a single pass of the cutting tool.

Because of the design and configuration of the machine disclosed in the Mitsubishi patent, the machine and methods as described therein are not capable of producing rough cut surfaces with substantially high rates of material removal because the Mitsubishi machine is not capable of achieving a desired rate of surface footage for material removal from the workpiece. Since the Mitsubishi patent is used to provide only finished surfaces, the cutting tool cannot engage a workpiece with a constant cutting force so that optimal shearing forces for rough surface machining can be achieved. Thus, the Mitsubishi patent cannot remove material from a workpiece using a controlled fracturing process nor can the apparatus and methods described therein be used for machining both open and closed surfaces.

### BRIEF SUMMARY OF THE INVENTION

Unlike the prior art machining techniques, the invention uses the controlled fracturing process to remove material from the workpiece. The controlled fracturing occurs when a material's yield strength and breaking strength are exceeded simultaneously. In other words, strain is instantaneous so there is no plastic deformation of the material being machined. Additionally, this also avoids attendant phenomena, like expansive heating and strain-hardening, which can chaotically complicate the machining process. Because prior art methods of contact machining are restricted to plastic deformation for removing material from a workpiece, complications are inherent in their operation and work to severely restrict performance in terms of productivity, precision, and applicability.

In order to avoid these shortcomings, the present invention's removal of material by controlled fracturing is useful for a number of reasons: (1) the present invention can remove material from a workpiece at a much higher rate by at least one or two orders of magnitude than prior art machining techniques; (2) the present invention mitigates and sometimes eliminates the chaotic effects of expansive heating and strain-hardening inherent in current methods of contact machining and so is more precise in the fit and finish it imparts to a part; (3) for the same reason, the invention can also produce shapes that are complex (e.g., highly curved airfoiling) and extreme (e.g., very thin cross-sections) that cannot be done using prior art machining methods; and (4) the invention is usable with materials, such as carbon fiber composites, which are typically too brittle for plastic deformation, i.e. their yield strength is identical to their breaking strength and so are difficult or impractical to machine by other prior art methods. Thus, a purpose of the present invention is to profile parts by means of contact machining more rapidly and precisely than existing art, including parts of shapes and materials that are impractical or impossible to profile with using machining techniques presently available in the art.

The invention uses non-rotary contact machining not known in prior art to induce controlled fracturing to profile workpieces into finished shapes. The invention combines the superior capabilities of turning and milling without the limitation of either. Generally, a lathe produces parts at faster material removal rates and with finer surface finishes than mill. However, the profiling operation of a lathe is restricted to a two-dimensional work envelope which limits the parts it can produce to those with circular cross-sections. A mill can profile within a three-dimensional work envelope, which permits the production of parts with a greater range of shapes, although at a slower material removal rate and with a rougher finish than a lathe. The present invention combines the advantages of the lathe and the mill in profiling operations without their limitations by producing parts with an unrestricted range of shapes with very fine surface finishes at high rates of material removal.

The profiling operations of lathes and mills are limited because they rely upon rotary motion to cut away material from the workpiece. Rotary motion creates a sufficiently high surface footage to remove material. Those skilled in the art will recognize that surface footage is the linear rate of movement of the cutting edge of the tool calculated by multiplying the revolutions per minute of the workpiece or tool by its circumference. However, rotary motion imposes symmetry about the axis of rotation upon either the shape of the part to be produced or the cutting tool used. In the case of the lathe, the workpiece rotates and the cutting tool does not. It is the need to rotate the workpiece that restricts the lathe to a two-dimensional work envelope and so limits the parts a lathe can profile to those with circular cross-sections, i.e., axial symmetry. In the case of the mill, the cutting tool rotates and the workpiece does not. This permits a three-dimensional work envelope and so the profiling of parts within a wide range of open and closed surfaces that may be flat or curved (including Bezier curves). However, the need to rotate the cutting tool, which imposes axial symmetry upon it, limits the shape and surface finish that a mill can produce on a workpiece and the material removal rate at which it can do so. Moreover, the rough surface finish left by milling often necessitates a secondary grinding operation or polishing by hand to create a finer finish on a part, therefore adding time and expense to its production.

Machine tools that profile by means of non-rotary methods exist in prior art, including planers, shapers, broaching machines and, more recently, U.S. Patent Publication No. U.S. 62003/0103829 to Suzuki et al. and Japanese Patent No. 63-123603 to Koreda et al., which are herein incorporated by reference. However, none of these machine tools are capable of roughing and finishing the unrestricted range of shapes provided by the present invention. This occurs since the profiling operations of these machine tools are either restricted to one-dimensional cutting paths within a two-dimensional work envelope or restricted to finish-machining operations of open surfaces.

An example of the former restriction is by Suzuki '829, which discloses a method of cutting long, straight rails made of hardened steel. In this method a static, i.e., a non-rotating cutting tool is fixtured at a starting point within a two-dimensional work envelope to cut the workpiece along a linear one-dimensional path. To cut along a different one-dimensional path, the tool must be re-fixtured at a different starting point within the work envelope. Like all other methods of non-rotary machining in the prior art, this device is constrained to a one-dimensional cutting path within a two-dimensional work envelope. It cannot produce the parts illustrated by 100 in FIG. 3, 500 in FIGS. 15, and 500 in FIG. 16. Lacking three-dimensional motion within a three-dimensional work envelope, none of these non-rotary methods of machining can produce anything more than simple shapes on a workpiece and so have only highly specialized and severely limited applications.

An example of the latter restriction is Koreda '629, which discloses an apparatus for modifying a conventional computer-numerical controlled machining center to use a non-rotating cutting tool to finish-machine a workpiece already roughed to near net-shape by another process to a three-dimensional shape restricted to open surfaces. This invention lacks the capability to produce a shape that has closed surfaces—i.e., areas that are pocketed, concaved, stepped, or partially bounded by protrusions. For example, the vane 102 relative to surface 104 in FIG. 3, the cavity 508 relative to the plane defined by axes 502 and 504 in FIG. 15, and the cavity 512 relative to the plane defined by axes 502 and 504 in FIG. 16. It can only produce surfaces that are open—i.e., a flat or gently curved surface with no section that declines along the axis perpendicular to the plane of the surface. In other words, it cannot produce surfaces that require significant plunging of the cutting tool into the workpiece. Furthermore, this invention lacks the capability to both rough- and finish-machine a workpiece to net-shape. It is also limited to feed rates and volumetric material removal rates typical of conventional rotary machining centers.

Therefore, the need exists to provide a method and apparatus to: (1) Move and/or drive a cutting tool through a workpiece without rotary motion at a sufficiently high speed to remove material by means of controlled fracturing (2) along a three-dimensional path within a three-dimensional work envelope to produce precision flat and curved shapes with both open and closed surfaces (3) first by rough-machining the workpiece to near net-shape and (4) then finish-machining it to completion with a surface finish of 4 to 16 microinches or finer (5) at material removal rates of 20 cubic inches per minutes or more at feed rates of 5,000 inches per minute or more (6) without the expense of secondary operations and manual labor.

### BRIEF DESCRIPTION OF THE DRAWINGS

The present invention will now be described with reference to the accompanying drawings wherein like reference numerals in the following written description correspond to like elements in the several drawings identified below.

FIG. 1 is a perspective view of a prior art machined part that can be produced by the non-rotary machining method of the present invention.

FIG. 2 is part view of the part depicted in FIG. 1 as machined by prior art milling techniques.

FIG. 3 is a partial view of the part depicted in FIG. 1 as machined by the present invention.

FIG. 4 is a front view of a non-rotary cutting tool used in accordance with an embodiment of the present invention to machine the part as depicted in FIG. 3.

FIG. 5 is a side view of the tool depicted in FIG. 4.

FIG. 6 is an elevation view of a prior art tool used in accordance with a prior art mill to machine the part as depicted in FIG. 2.

FIG. 7 is a bottom view of the tool depicted in FIG. 6.

FIG. 8 is a bottom view of the prior art tool depicted in FIGS. 6 and 7 as used to machine a part.

FIG. 9 is a front view of a non-rotary cutting tool used in accordance with various embodiments of the present invention.

FIG. 10 is a side view of the tool depicted in FIG. 9.

FIG. 11 illustrates perspective views of different insertable cutting edges for the tool depicted in FIGS. 9 and 10.

FIG. 12 is a front view of an axially asymmetric non-rotary cutting tool used in accordance with various embodiments of the present invention.

FIG. 13 is a side view of the tool depicted in FIG. 12.

FIG. 14 is an elevation view of the tool depicted in FIGS. 9 and 10 being used to machine a part in accordance with one aspect of the present invention.

FIG. 15 is a perspective view of a part machined in accordance with the “3-axis” embodiment of the present invention.

FIG. 16 is a perspective view of another part machined in accordance with the “4-axis” embodiment of the present invention.

FIG. 17 is a perspective view of a non-rotary machining apparatus in accordance with the “3-axis” and “4-axis” embodiments of the present invention.

FIG. 18 is a flow chart of the non-rotary machining method of the present invention machining the part depicted in FIG. 15 in accordance with the “3-axis” embodiment of the present invention.

FIG. 19 is a flow chart of the non-rotary machining method of the present invention machining the part depicted in FIG. 16 in accordance with the “4-axis” embodiment of the present invention.

FIG. 20 is a flow chart of the non-rotary machining method of the present invention machining a complex surface, such as a NURBS surface, in accordance with a “5-axis” or “T-axis” embodiment of the present invention.

FIGS. 21A, 21B and 21C are chart diagrams illustrating elastic, plastic, and controlled-fracture phases respectively of deformation.

### DETAILED DESCRIPTION

Distinction over the Prior Art. The present invention is distinguished from current machining methods and apparatuses for profiling operations by: (1) A non-rotating cutting tool that is unconstrained by axial symmetry (2) driven along a one-, two-, or three-dimensional cutting path (3) within a three-dimensional work envelope (4) to remove material from a non-rotating workpiece (5) at a sufficiently high federate to remove material by means of controlled fracturing. No other method or apparatus for machining possesses all of these characteristics. As a consequence of these characteristics the present invention can: (1) rough-machine a workpiece to near net-shape and then precisely finish-machine it (2) to an unrestricted range of shapes with both open and closed surfaces, (3) including those with thin cross-sections, (4) at very fine surface finishes (5) at high volumetric rates of material removal. No other method or apparatus for machining can produce these results on a single machine tool in a single profiling operation. The comparison of these characteristics and capabilities between the present invention and prior art are illustrated in Table 1 below.

TABLE 1
COMPARISON OF CURRENT MACHINING METHODS
TO NON-ROTARY MACHINING METHOD

| | 1-D | 2-D | 3-D | 2-D | 3-D | | Thin | | Rapid |
|---|---|---|---|---|---|---|---|---|---|
| | Tool | Tool | Tool | Work | Work | Complex | Cross- | Fine | Mat'l |
| Method | Path | Path | Path | Envelope | Envelope | Shapes | Sections | Finish | Removal |
| Non-Rotary | X | X | X | X | X | X | X | X | X |
| Machining | | | | | | | | | |
| Milling | X | X | X | X | X | X | | | |
| Turning | X | X | | X | | | X | X | X |
| Shaping | X | | | X | | | | | X |
| Planing | X | | | X | | | | | X |
| Broaching | X | | | X | | | | | |
| Suzuki | X | | | X | | | | | |
| Invention | | | | | | | | | |
| Koreda | X | X | X | X | X | | | | |
| Invention | | | | | | | | | |

The present invention is most directly compared to the profiling operations of mills, because it mostly obsoletes the need for such. The primary utility a mill will retain is hole-making within a three-dimensional work envelope. The reason for this obsolescence is that the non-rotary machining method of the present invention can execute any profiling operation that a mill can: (1) Without any restriction of the shape required for the part (2) with a finer lathe-like surface finish, thus eliminating or reducing the need for grinding or polishing, (3) at material removal rates generally five to forty times faster. These advantages are a direct consequence of the present invention employing a static (i.e., non-rotating) cutting tool instead of a rotating one. This difference is well demonstrated by the significantly increased material removal rates of the present invention, as will be fully described later. Furthermore, an apparatus embodying this method will generally be less expensive, less complex, and sturdier than a comparable mill.

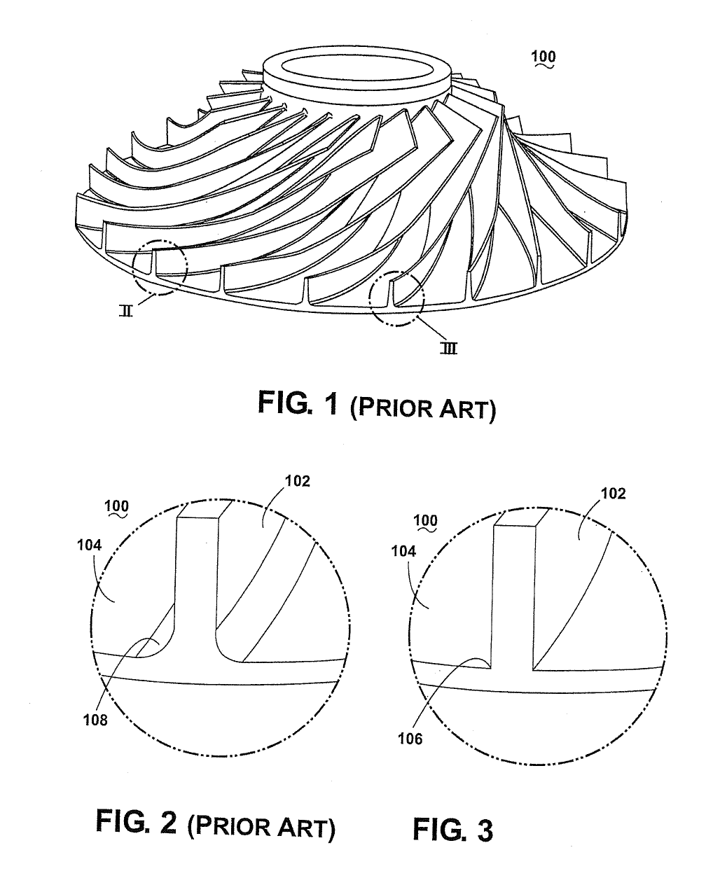

Unrestricted Range of Shapes. Despite their significant disadvantages mills are presently used to machine parts with complex shapes, such as large die sets used in the automotive industry to form car roofs, hoods, and fenders or smaller precision components like impellers or the like. For example, FIG. 1 illustrates a perspective view of a prior art impeller 100 that can be produced by the non-rotary machining center and methods of the present invention. The area depicted by “II” indicates a close-up as shown in FIG. 2 while the area “III” indicates that shown in the FIG. 3. Those skilled in the art recognize that amongst existing machine tools, mills are the least restricted in the shapes they can produce in a profiling operation. However, the need to rotate the cutting tool imposes the constraint of axial symmetry upon it. That, in turn, restricts to the shape of the tool the range of shapes that a mill can cut into a workpiece.

As specifically seen in FIG. 2 and FIG. 3 the differences in the type of cut using prior art milling techniques and the non-rotary machining method of the present invention are clearly illustrated. FIG. 2 illustrates a close-up of the type of cut as used with prior art milling techniques that create a radius between edges while FIG. 3 uses present machining methods to create an orthogonal edge. With regard to FIG. 3, an example of the process creates an orthogonal interior corner formed by the intersection of two curved surfaces. This type of surface cannot be produced using prior art milling techniques. Both FIGS. 2 and 3 illustrate an impeller 100 utilizing a series of vanes 102, that extend outwardly from a concave surface 104. As shown in FIG. 3, the intersection of a vane 102 and the surface 104 creates a sharp inside corner 106.

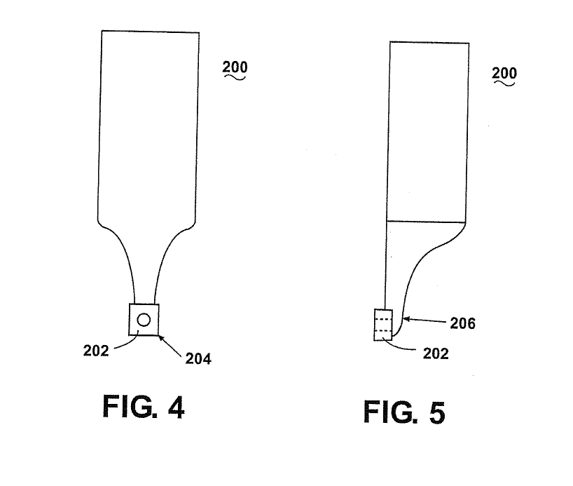

FIG. 4 is a front view of a non-rotary cutting tool used in accordance with an embodiment of the present invention used to machine the part as depicted in FIG. 3. FIG. 5 is a side view of the tool depicted in FIG. 4. Because the machining method of the present invention employs a non-rotating cutting tool 200, axial symmetry is not a requirement for the tool. Therefore, the tool 200 does not need to be relieved in all directions to clear the curved surfaces 102,104 of the impeller 100. The tool 200 needs only to be relieved on the posterior side 206 that is perpendicular to the direction of its cutting path. Therefore, the tool's cutting edge 202 can feature a sharp corner 204 which can be continuously re-oriented along the path of the corner 106, by means of the present invention, to machine it as specified. For this reason, the present invention, unlike a mill, is unrestricted in the shapes it can cut in a profiling operation.

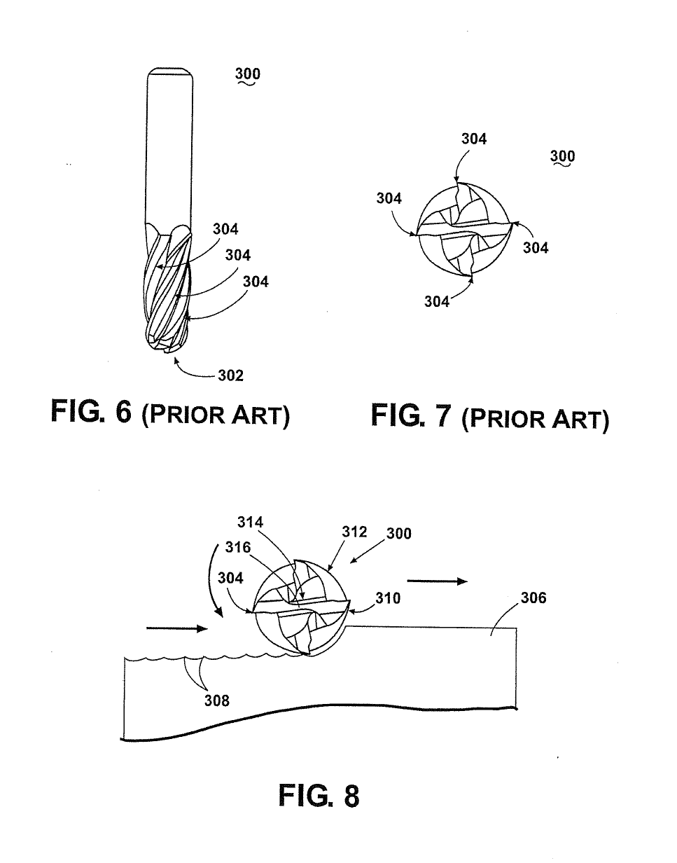

FIG. 6 is an elevation view of a prior art tool used in accordance with a prior art mill to machine the part as depicted in FIG. 2. FIG. 7 is a bottom view of the tool depicted in FIG. 6. In order to cut the side of the vane 102 and the concave curve of the surface 104 to specification, a mill must use an axially symmetrical cutting tool like that shown in FIG. 6. As seen in FIGS. 6 and 7, the tool 300 includes a spherical nose 302 and cutting edge 304. The tool 300 is relieved in all directions to clear the curved surfaces 102, 104 specified for the impeller 100. FIG. 2 illustrates the prior art techniques where the vanes 102 and the concave surface 104 of the milled impeller 100 are to specification. Instead of the sharp inside corner 106 as seen in FIG. 3, at their intersection is a large radius 108 conforming to the spherical nose 302 of the mill's rotating cutting tool.

Finer Surface Finishes. Even when a mill can profile a shape to its specified dimensions, it will leave a rough or scalloped edge. As noted above, prior art FIG. 8 illustrates the cutting tool 300 as frequently used by a mill in profiling operations. The tool 300 includes a number of cutting edges 304, called flutes, which cut material away from the workpiece 306 as the tool 300 rotates. Because the flutes 304 are spaced apart from each other, material is not cut away constantly from the workpiece 306. Instead, the material is only cut away during the time when one of the four flutes 304 is in contact with the workpiece 306. Consequently, the removal of material by the rotating tool 300 is not consistent as it moves through the workpiece 306. The result is an uneven surface marked by a series of scallops 308. If these scallops 308 are excessive or otherwise unwanted, it is necessary to grind or manually polish the workpiece 306 after completion of the profiling operation on the mill to produce a sufficiently fine finish on the completed part.

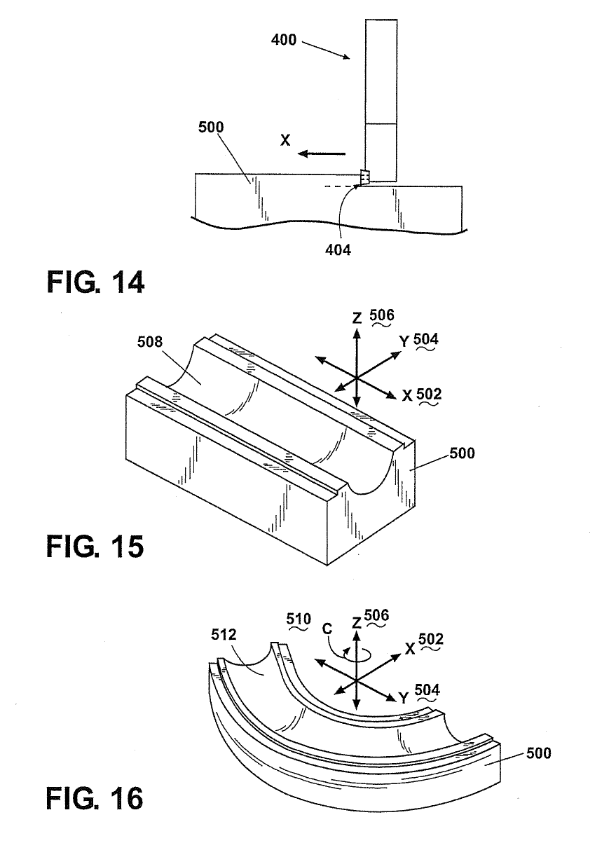

FIG. 9 is a front view of a non-rotary cutting tool used in accordance with various embodiments of the present invention while FIG. 10 is a side view of the tool depicted in FIG. 9. Unlike the flutes 304 of a mill's rotating cutting tool 300, FIGS. 9-10 illustrate the non-rotating tool 400 with a cutting edge 404 that, when employed by the present invention in a profiling operation, is in constant, stable contact with the workpiece 500 as depicted in FIG. 14. As a result, there are no scallops left on the cut surface of the workpiece 500. For this reason, the present invention produces a much finer surface finish in a profiling operation than a mill does, thus eliminating or reducing the need for subsequent grinding or polishing.

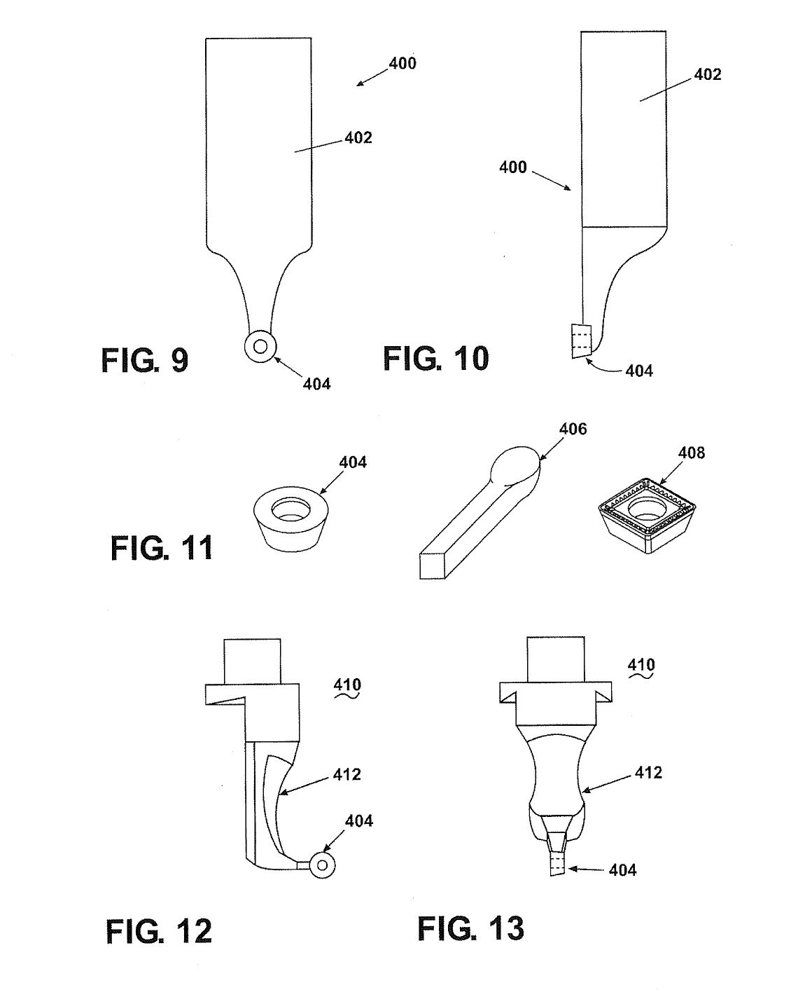

Faster material removal rates. FIG. 11 illustrates perspective views of different insertable cutting edges for the tool depicted in FIGS. 9 and 10. Alternatively to that shown in FIGS. 9-10, the non-rotating cutting tool 400 may include a cutting edge 404 that is either inserted into or integral to the tool body 402. It should be evident to those skilled in the art that the cutting edge 404 is illustrated as a “circular edge” that may be altered to a sharp point, square face 408 or other geometries such as shown in FIG. 11 to machine the desired shape and surface finish on a workpiece.

FIG. 12 illustrates a front view of an axially asymmetric non-rotary cutting tool used in accordance with various embodiments of the present invention. FIG. 13 is a side view of the tool depicted in FIG. 13. The tool body 412 can be of any shape necessary to support the cutting edge 404 while providing relief for it to machine deep or other spatially constrained features into a workpiece. An example of this tool body is illustrated in FIGS. 12-13. Often a non-rotating cutting tool 400 such as that depicted in FIGS. 9-10 will be the same as, or similar to, cutting tools used for turning. This is due to the fact that the non-rotary machining method of the present invention does not restrict the operation of the tool as does turning to a two-dimensional cutting path within a two-dimensional work envelope. Therefore, a non-rotating cutting tool can possess cutting edges, tool body shapes, and asymmetrical features not found in turning tools to machine complex shapes not possible with turning.

FIG. 14 illustrates a non-rotating cutting tool 400 removing material from a workpiece 500 in accordance with an embodiment of the present invention. Once in contact with the workpiece 500 the cutting edge 404 of the tool 400 is continuously engaged in a uniform cutting motion that removes material with a constant force. This is in sharp contrast to the variable force of the rotating cutting tool 300 used by a mill in a profiling operation, as depicted in FIG. 8. In that instance each flute 304 of the tool 300 rotates towards the workpiece 306 and swings from no engagement to full engagement to no engagement again. The variation in force is the result in the change of the chip load of the tool 300 as the mass of material that the flute 304 is removing increases from zero to full chip load to zero again. Furthermore, the force of a rotating cutting tool 300 also varies because its acceleration decreases from maximum surface footage at its outside diameter to zero at its centerline, so that the nature of its cutting motion ranges from shearing at the maximum radial extent of the flute 310 to tearing along most the flute's edge 312 to scraping along its bottom 314 to pushing through material at its center 316.

The difference between the two types of cutting motions is that a rotating cutting tool 300 leaves a series of scallops 308 from side-cutting on the surface of the workpiece 306 and a rough finish from bottom-cutting, whereas a non-rotating cutting tool 400 leaves a smooth finish on the workpiece 500. This is because the variable force of a rotating cutting tool 300 has the effect of mostly tearing material away from the workpiece 306 rather than shearing it as does a non-rotating cutting tool 400 from the workpiece 500. Additionally, by shearing material with constant force to remove it rather than tearing it away with variable force, the non-rotary machining method can produce parts with thinner cross-sections more precisely, more quickly, and with less scrap than is possible with milling. Also, shearing instead of tearing keeps the heat from the friction of the cutting motion in the chip rather than the cutting tool 400 or the workpiece 500, which improves tool life and reduces defects and distortions in the finished part, especially those with complex shapes or thin cross-sections. Less obvious is that the variable force of a rotating cutting tool 300 introduces a much larger element of chaos into the cutting motion than does the constant force of a non-rotating cutting tool 400. This disorder, often manifesting itself as chatter, increases the unpredictably of a profiling operation on a mill compared to the present invention and therefore significantly restricts the range, performance, and productivity of mills even for simple operations. The constancy of force in the cutting motion of a non-rotating cutting tool 400 along a three-dimensional path through a three-dimensional work envelope is the essence of the present invention which cannot be replicated by any machining method or apparatus of prior art.

The stable, constant cutting force that the present invention applies through a non-rotating cutting tool ensures that energy is not drawn away from the task of material removal in the form of chaotic motion such as chatter. Therefore, constancy of the cutting force is critical to increasing the material removal rate of the present invention in comparison to milling. Even more fundamental to the present invention's significantly faster material removal rates is that, unlike a mill, none of the cutting force it delivers is diverted to the rotation of the cutting tool. Because the rate of material removal is the result of the depth of cut multiplied by the width of cut multiplied by the linear rate of the cutting tool's motion through the workpiece, commonly called the “feed rate,” the rotation of the cutting tool is not a direct factor. Consequently, any cutting force that must be diverted to rotation of the tool, commonly called the “cutting speed” or “surface footage”, reduces the force available to increase the feed rate and, in turn, increases the material removal rate. Table 2 compares the non-rotary method of the present invention to milling for four common machining operations using the best practices for each to illustrate the greater material removal rates of the present invention by factors of 12, 23, 33, and even 200. For this and the other reasons stated above, the present invention can remove material from a workpiece in profiling operations at rates generally 5 to 40 times faster than a mill.

TABLE 2
COMPARISON OF MATERIAL REMOVAL RATES FOR 41xx SERIES ALLOY STEEL WORKPIECE

| | | | | | | | Material | |
|---|---|---|---|---|---|---|---|---|
| | | | Depth | Width | Cutting | | Removal | Non-Rotary/ |
| | Machining | | of Cut | of Cut | Speed | Feed Rate | Rate | Milling |
| Operation | Method | Cutting Tool | (mm) | (mm) | (m/min.) | (m/min.) | (c.c./min.) | Comparison |
| surfacing | milling per | 110 mm dia. | 0.25 | 100 | 150 | 2.0 | 50.0 | 12 |
| | prior art | carbide | | | | | | |
| | | inserted | | | | | | |
| | | surface mill | | | | | | |
| | non-rotary | 20 mm dia. | 6.5 | 1.5 | n/a | 60 | 582 | |
| | per present | carbide | | | | | | |
| | invention | inserted | | | | | | |
| | | cutter | | | | | | |
| side milling | milling per | 20 mm dia. | 10 | 18 | 45 | 0.18 | 32.4 | 23 |
| | prior art | carbide | | | | | | |
| | | end mill | | | | | | |
| | non-rotary | 10 mm wide | 3.3 | 7.5 | n/a | 30 | 743 | |
| | per present | carbide | | | | | | |
| | invention | inserted | | | | | | |
| | | cutter | | | | | | |
| rough | milling per | 20 mm | 3.3 | 4 | 300 | 1.5 | 19.8 | 33 |
| contouring | prior art | carbide | | | | | | |
| | | inserted | | | | | | |
| | | ball-nose | | | | | | |
| | | end mill | | | | | | |
| | non-rotary | 20 mm dia. | 6.5 | 3.3 | n/a | 30 | 644 | |
| | per present | carbide | | | | | | |
| | invention | inserted | | | | | | |
| | | cutter | | | | | | |
| finish | milling per | 3 mm dia. | 0.6 | 0.25 | 120 | 1.0 | 0.15 | 200 |
| contouring | prior art | carbide | | | | | | |
| | | ball-nose | | | | | | |
| | | end mill | | | | | | |
| | non-rotary | 3 mm dia. | 1.0 | 0.25 | n/a | 120 | 30 | |
| | per present | carbide | | | | | | |
| | invention | inserted | | | | | | |
| | | cutter | | | | | | |

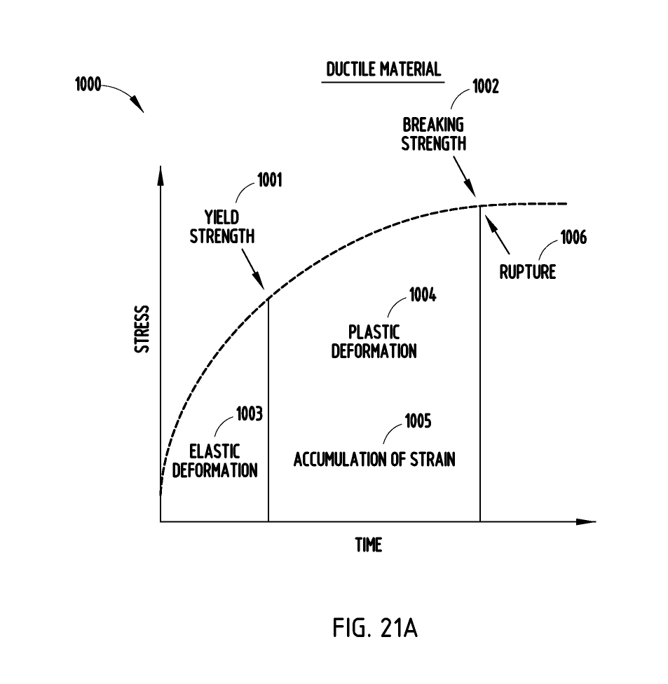

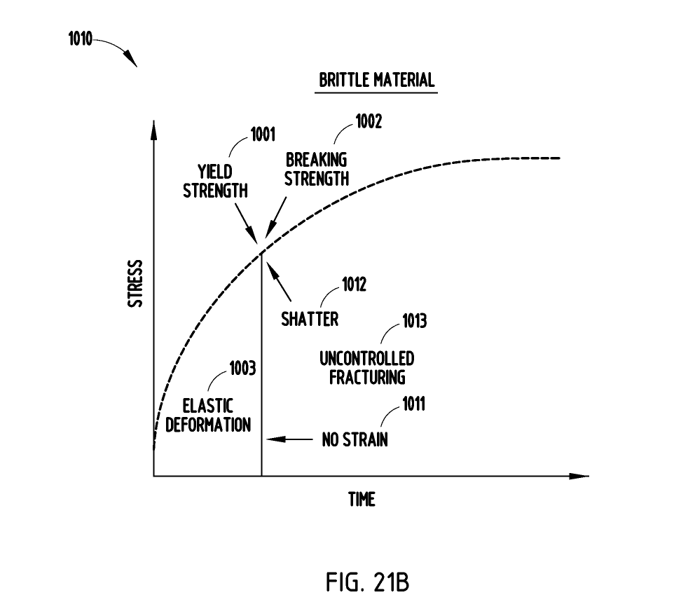

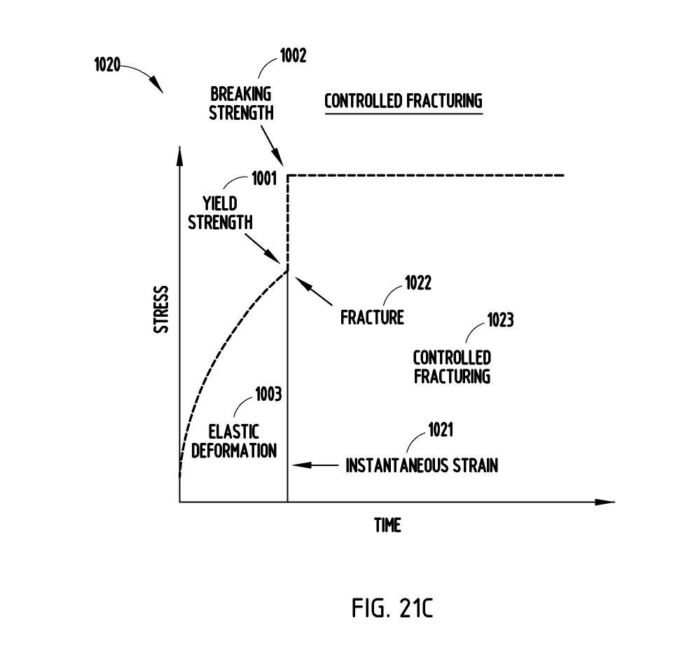

Deformation by controlled fracturing. The invention's high volumetric rate of material removal are made possible by inducing controlled fracturing in the workpiece. FIGS. 21A, 21B and 21C are charts illustrating the nature of the elastic, plastic, and controlled-fracture phases of deformation respectively. As seen in these charts, depending upon the force driving the cutting tool through the workpiece, the apparatus and method of the present invention remove material from the workpiece by either plastic deformation 1004 or controlled fracturing 1023. In both cases, it does so at volumetric rates of material removal one or two orders of magnitude greater than that of existing art. However, controlled fracturing 1023 is the superior process, because it mitigates or eliminates the expansive heating and strain-hardening that characterize plastic deformation 1004. These effects cause difficulties in the machining process by degrading speed and precision; limiting the range of shapes and materials that can be machined; shortening machine and tool life; and destabilizing production with unpredictable factors. To the extent that the cutting force that the present invention applies to the material of a workpiece approaches instantaneous strain 1021, and achieves controlled fracturing 1023, the period of plastic deformation 1004 is reduced and so are its adverse effects.

As described herein, controlled fracturing 1023 offers the ideal level of deformation in a profiling operation, and is the process of contact machining that works to achieve certain predefined goals. As seen in each of FIGS. 21A and 21C, deformation of a ductile material occurs at three levels 1003, 1004, and 1023. The first level is elastic deformation 1003, in which the material will return to its original shape once it is relieved of stress. If the stress exceeds the material's yield strength 1001, then the second level, plastic deformation 1004, is reached and the material is permanently deformed. The continued application of stress to a plastically deformed material will cause strain to accumulate 1005 until it exceeds the material's breaking strength 1002 allowing it to rupture 1006. With regard to FIG. 8, for the methods of contact machining in existing art, this level of deformation is the best that can be achieved and is observed as the cutting tool 300 is operating to separate irregularly chipped material 308 from a workpiece 316.

Generally, the longer it takes strain to accumulate 1005, the greater are the effects of expansive heating and strain-hardening, and the more severe is the resulting chaos in the material removal process. Therefore, reducing or even eliminating the time it takes the accumulation of strain 1005 to rupture 1006 a material is desirable. Thus, the ideal is instantaneous strain 1021, in which a material's yield strength 1001 and breaking strength 1002 are exceeded at the same time. This, in effect, makes a ductile material 1000 behave like one that is brittle 1010, in which no plastic deformation 1004 occurs as a cutting tool 400 removes material from a workpiece 500, as illustrated in FIG. 21B. Instead of pulling a material apart by rupturing it 1006, the force of the cutting tool cracks 1022 the workpiece along lines of fracture to separate pieces of material, as seen in FIG. 21C. This process is termed “controlled fracturing” 1023, which is the third level of deformation. The shape, orientation, and direction of the tool's cutting edge determine how the material will fracture 1022 by concentrating the heat generated from the cutting tool's 400 contact with the workpiece 500 into adiabatic bands emanating from the perimeter of the cutting edge 404 in the direction of the cutting tool's motion. The heating within these bands causes micro-cracks to form which then connect under the continued stress of the cutting force and fractures material loose from the workpiece along a line conforming to the perimeter of the cutting edge 404 406 408. The present invention controls these cutting tool factors to produce the desired shape and finish without the adverse effects of plastic deformation 1004 that limit the performance of all other methods of contact machining in existing art.

By way of example, the present invention provides a method for machining a workpiece using a machine tool without rotating either the cutting tool or the workpiece to provide sufficient driving force for the cutting tool to remove material from the workpiece through deformation by shear stresses inducing controlled fracture. The method includes_positioning a cutting tool at a starting position near the surface of a non-rotating workpiece. The cutting tool is moved along a three-dimensional cutting path without rotation of either the cutting tool or the workpiece at a substantially high surface footage so as to remove material from the workpiece to impart thereon a rough three-dimensional open or closed surface approximating the finished shape. The cutting tool then repositioned as needed at a starting position for each additional path needed to produce rough and finish machine a three-dimensional precision shape and finish of both open and closed surfaces on the workpiece.

Thereafter, the cutting tool is operated in a three-dimensional work envelope relative to the workpiece. The cutting tool can be axially asymmetric in shape and the cutting tool can be moved along a plurality of cutting paths through the workpiece in any simultaneous combination of three dimensions such that at least one of the paths is not coplanar. Those skilled in the art will recognize that “simultaneous motion” or “simultaneous combination of three dimension” is a common term in CNC machining. It means the cutting tool move along more than one axis at a time. In this case, our invention can move the cutting tool on the X, Y and Z axes at the same time along a straight or curved path. This is superior to broaching, planing, and shaping which are machining processes that can move the cutting tooling only on one axis at a time.

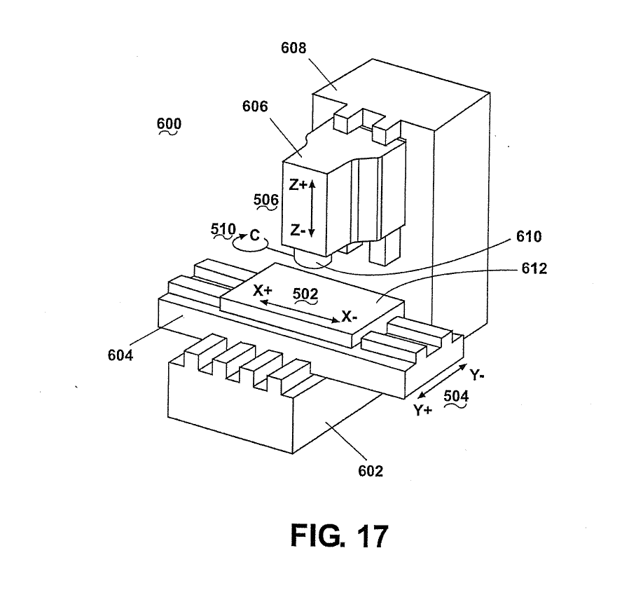

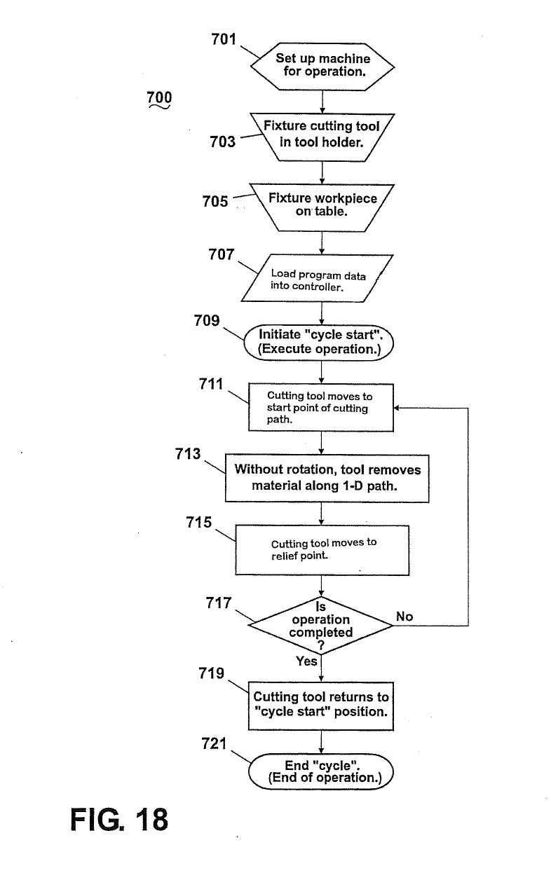

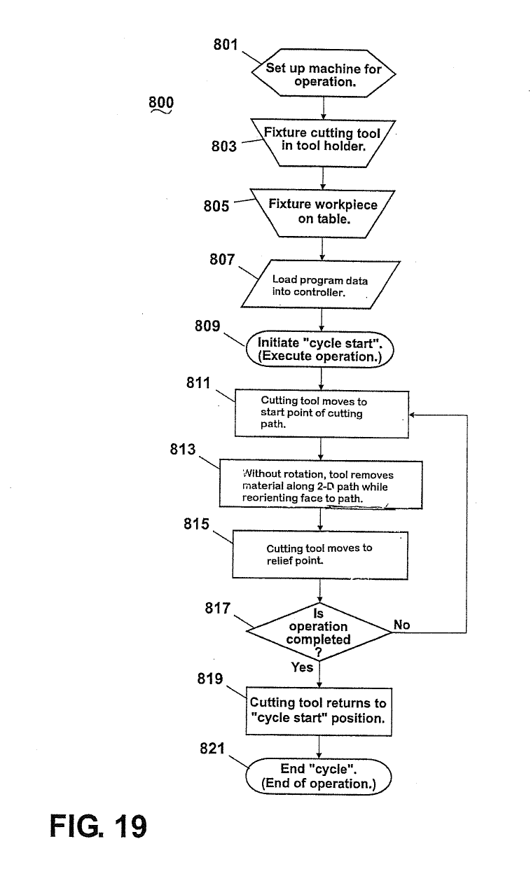

Embodiments of the apparatus. FIG. 17 is a perspective view of a non-rotary machining apparatus in accordance with the “3-axis” and “4-axis” embodiments of the present invention. The apparatus employing the non-rotary machining method of the present invention can be embodied in a variety of configurations. In contrast to that shown in FIG. 17, these embodiments are comparable to those of computer numerical controlled mills (known in the trade as “machining centers”), except that the present invention does not use a spindle to rotate a cutting tool. Instead, as seen in FIG. 9, a non-rotary cutting tool is used in accordance with various embodiments of the present invention. In this illustration a tool holder 610 replaces the spindle into which a non-rotating cutting tool 400 is affixed. The simplest embodiment of the present invention is a “3-axis” machine 600, which can drive the cutting tool along any one of the three linear axes 502 504 506, or any combination of them (under certain circumstances), that together define the machine's three-dimensional work envelope. FIG. 15 illustrates a workpiece where a “3-axis” machine is sufficient to machine the circular cavity 508 into the workpiece 500 by means of the process flowcharted in FIG. 18 described hereinafter. Yet another basic embodiment is a “4-axis” machine 600, which has all of the three-axis linear motion of the “3-axis” machine plus a “rotary axis” 510 to continuously re-orient the cutting tool's face 404 in any direction to maintain its perpendicularity to a level two-dimensional cutting path. Maintaining perpendicularity optimizes the performance of the cutting tool and thus maximizes the range of shapes the machine can cut. The mechanism for this fourth axis 510 can be either a rotary tool holder 610 to which the cutting tool 400 is attached or a rotary table 612 to which the workpiece 500 is attached. By either means, a “4-axis” machine is sufficient to machine the curved circular cavity 512 into the workpiece 500 illustrated in FIG. 16 by means of the process flowcharted in FIG. 19 described hereinafter.

FIG. 18 is a flow chart of the non-rotary machining method of the present invention machining the part depicted in FIG. 15 in accordance with the “3-axis” embodiment of the present invention. The non-rotary machining method 700 includes the steps of setting up the machine for operation 701. A cutting tool is fixtured in a tool holder 703 and a workpiece is fixtured on a table 705. Tool and cutting path data is then loaded into the machine's controller 707 and a cycle start is initiated to execute operation 709. The tool then moves toward the workpiece to the start point of the first cutting path 711 and then removes material from the workpiece along a 1-dimensional cutting path without rotation 713. At the end point of the cutting path the tool moves to a relief point above the workpiece 715 and a determination is made if the operation is completed 717. If not, the operation continues with the cutting tool moving to the start point of the next cutting path 711. If the operation is completed, the cutting tool returns to the cycle start position 719 and the operation ends 721.

FIG. 19 is a flow chart of the non-rotary machining method of the present invention machining the part depicted in FIG. 16 in accordance with the “4-axis” embodiment of the present invention. The method 800 includes the steps of setting up the machine for operation 801 where the cutting tool is fixtured in a tool holder 803. A workpiece is then fixed on the table 805 and the tool and cutting path data is loaded into the controller 807. Cycle start is initiated 809 and the cutting tool moves toward the workpiece to the start part of the first cutting path 811. The cutting tool then removes material from the workpiece along a level 2-dimensional cutting path without rotation while tool holder continuously re-orients the tool to maintain the perpendicularity of the face of the cutting edge to the cutting path 813. At the end point of the cutting path the tool moves to a relief point above the workpiece 815. A determination is then made if the operation is completed 817. If not, the cutting tool moves to the start point of the next cutting path 811. If the operation is completed, then the cutting tool returns to the cycle start position 819 and the operation ends 821.

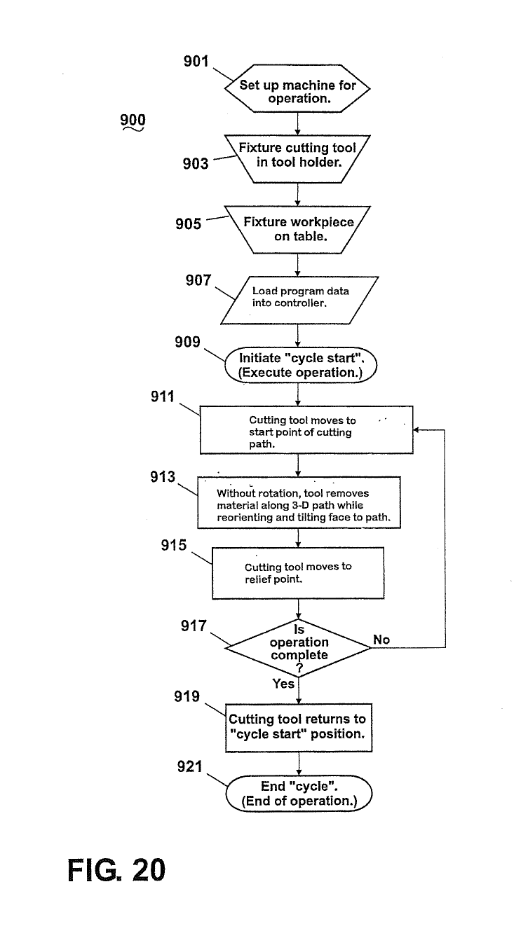

Still more complex embodiments are the “5-axis” and the “7-axis” machines. These embodiments have all of the three-axis linear and fourth-axis rotary motions of the “4-axis” machine plus additional rotary or tilt axes to orient the cutting tool's face in any direction to maintain its perpendicularity to any three-dimensional cutting path. These machines are unrestricted in the shapes and surfaces they can produce, including NURBS surfaces, by means of the process flowcharted in FIG. 20.

Flow chart of the method. FIG. 20 is a flow chart of the non-rotary machining method in accordance with a “5-axis” or “7-axis” embodiment of the present invention. The process 900 includes the step of setting up the machine for operation 901 and fixturing the cutting tool in a tool holder 903. The workpiece is fixtured on the table 905 and the tool and cutting path is loaded into the controller 907. Cycle start is initiated 909 and the cutting tool moves to the start point of the first cutting path 911. The cutting tool then removes material from the workpiece along a 3-dimensional cutting path without rotation while the tool holder continuously re-orients and tilts the tool to maintain the perpendicularity of the face of the cutting edge to the cutting path 913. A determination is made if the operation is completed 917. If not completed, the cutting tool moves to the start point of the next cutting path 911 and the operation continues. If the operation is complete, the cutting tool returns to the cycle start position 919 and the operation ends 921. Thus, the method of the present invention as described in FIGS. 18-21A, 21B and 21C, overcome the limitations of lathes and mills in profiling operations by employing a non-rotary method of machining and eliminates milling for most profiling operations.

While the present invention has been described in terms of the preferred embodiments discussed in the above specification, it will be understood by one skilled in the art that the present invention is not limited to these particular preferred embodiments, but includes any and all such modifications that are within the spirit and scope of the present invention as defined in the appended claims.

What is claimed is:

1. A method for machining a workpiece using a machine tool without rotating either the cutting tool or the workpiece to provide sufficient driving force for the cutting tool to remove material from the workpiece through deformation by shear stresses inducing controlled fracture comprising the steps of:
positioning a cutting tool at a starting position near the surface of a non-rotating workpiece;
moving the cutting tool along a three-dimensional cutting path without rotation of either the cutting tool or the workpiece at a substantially high surface footage so as to remove material from the workpiece to impart thereon a rough three-dimensional open or closed surface approximating the finished shape; and
repositioning the cutting tool as needed at a starting position for each additional path needed to produce rough and finish machine a three-dimensional precision shape and finish of both open and closed surfaces on the workpiece.

2. A method for machining a workpiece using a non-rotary machine tool as in claim 1, wherein the step of positioning includes the step of:
orienting the cutting tool relative to the workpiece at any angle relative to the predetermined path.

3. A method for machining a workpiece using a non-rotary machine tool as in claim 1, further including the step of:
operating the cutting tool in a three-dimensional work envelope relative to the workpiece.

4. A method for machining a workpiece using a non-rotary machine tool as in claim 1, including the step of:
utilizing a cutting tool that is axially asymmetric in shape.

5. A method for machining a workpiece using a non-rotary machine tool as in claim 1, wherein the step of moving further includes the step of:
moving the cutting tool along a plurality of cutting paths through the workpiece in any simultaneous combination of three dimensions.

6. A method for machining a workpiece using a non-rotary machine tool as in claim 5, wherein the plurality of cutting paths through the workpiece in any simultaneous combination of three dimensions in which at least one of the paths are not coplanar.

7. A method for removing material from a workpiece for providing a substantially fine three-dimensional surface finish, similar to that obtained by turning as opposed to milling, comprising the steps of:
a) positioning a non-rotating cutting tool near the surface of a non-rotating workpiece;
b) driving at a sufficient surface footage the non-rotating cutting tool through the non-rotating workpiece along a cutting path in any simultaneous combination of three dimensions three-dimensional combination so that material is removed by shear stresses inducing controlled fracture and not chaotic rupture from the surface workpiece to impart thereon a rough three-dimensional open or closed surface approximating the finished shape;
c) repositioning the face of the tool within a three-dimensional work envelope relative to the workpiece so as to remove additional material for rough machining a three-dimensional precision shape on open surface and closed surface on the workpiece; and
d) repeating steps a) through c) to produce a finely machined three-dimensional complex finished surface on the workpiece without chaotic rupture of the material.

8. A method for removing material from a workpiece as in claim 7, wherein the predetermined surface footage is selected to eliminate reduce the distorting effects of heat, friction, and cutter chatter upon the finished dimensions of the workpiece by reducing, as nearly as possible, the amount of time strain accumulates in the workpiece from plastic deformation to zero.

9. A method for removing material from the workpiece as in claim 7, further comprising the step of:
changing the orientation of both the non-rotating cutting tool and non-rotating workpiece within a three-dimensional space in order to either more rapidly machine the complex surface or produce shapes and finishes not otherwise possible in a single operation.

10. A method for removing material from a workpiece as in claim 7, further comprising the step of:
altering the position of a work table for changing the orientation of the workpiece.

11. A method for removing material from a workpiece as in claim 7, further comprising the step of:
utilizing the non-rotary cutting tool that is axially asymmetric in shape.

12. A method for removing material from a workpiece as in claim 7, further comprising the step of:
moving the non-rotary cutting tool along a plurality of straight cutting paths through the workpiece in any simultaneous combination of three dimensions.

13. A method for removing material from a workpiece as in claim 12, wherein the plurality of straight cutting paths through the workpiece in any simultaneous combination of three dimensions in which at least three paths are not coplanar.

14. A method of machining a surface of a workpiece comprising:
providing a machine capable of performing a subtractive machining operation;
providing a cutting tool;
fixturing the cutting tool to the machine capable of performing a subtractive machining operation;
moving the cutting tool at a substantially high surface footage of its cutting edge relative to the surface of the workpiece to impart thereon a rough three-dimensional open or closed surface approximating the finished shape through deformation by shear stresses inducing controlled fracture and not chaotic rupture without rotation of either the cutting tool or the workpiece such that cutting tool can be oriented in any of three dimensions with respect to the workpiece while a portion of the cutting tool is in contact with the workpiece to thereby cut a portion of the workpiece away and machine into it a three-dimensional complex surface having an open surface or closed surfaces on the finished workpiece; and
repeatedly moving the cutting tool along a plurality of cutting paths through the workpiece in any simultaneous combination of three dimensions three-dimensional combination to produce a finished surface on the workpiece.

15. A method of machining a surface into a workpiece as in claim 14, further including maintaining the workpiece in a stationary position with respect to the machine while the cutting tool is moved.

16. A method of machining a surface of a workpiece as in claim 14, wherein the movement of the cutting tool along straight cutting paths through the workpiece in any simultaneous combination of three dimensions.

17. A method of machining a surface of a workpiece as in claim 16, wherein the plurality of straight cutting paths through the workpiece are in any simultaneous combination of three dimensions in which at least three paths are not coplanar.

18. A method of machining a surface of a workpiece as in claim 14, wherein the movement of the cutting tool includes moving the cutting tool along curved cutting paths through the workpiece in any simultaneous combination of three dimensions three-dimensional combination.

19. A method of machining a surface into a workpiece as in claim 18, wherein the movement of the cutting tool includes moving the cutting tool along a plurality of curved paths through the workpiece in any simultaneous combination of three dimensions three-dimensional combination.

20. A method of machining a surface into a workpiece as in claim 19, wherein the plurality of curved cutting paths through the workpiece in any combination of three dimensions simultaneously includes at least three curved cutting paths that are not coplanar.

21. A method of machining a three-dimensional complex surface into a workpiece as in claim 14, wherein the machine is programmable and the method further includes programming the machine to move the cutting tool along a plurality of three-dimensional cutting paths through workpiece that are calculated to remove material from it to leave a precision complex surface with a fine finish.

22. A method of machining a three-dimensional complex surface into a workpiece as in claim 21, wherein a programmed movement of the cutting tool includes moving the cutting tool in cutting paths through the workpiece in any simultaneous combination of three dimensions.

23. A method of machining a three-dimensional complex surface into a workpiece as in claim 21, wherein a programmed movement of the cutting tool includes moving the cutting tool along a plurality of cutting paths through the workpiece in any simultaneous combination of three dimensions.

24. A method of machining a three-dimensional complex surface into a workpiece as in claim 23, wherein the plurality of straight or curved cutting paths through the workpiece in any simultaneous combination of three dimensions includes at least three cutting paths that are not coplanar.

25. A method of machining a three-dimensional complex surface into a workpiece as in claim 14, wherein the surface of the workpiece is a curved surface.

26. A method of machining a three-dimensional complex surface into a workpiece as in claim 14, further comprising the step of:
utilizing a cutting tool that is axially asymmetric in shape.

27. A non-rotary shaping center for machining a workpiece comprising:
a tool holder;
a non-rotating cutting tool having a cutting edge positioned within the tool holder; and
wherein the non-rotating cutting tool is oriented at any angle relative to a predetermined path so that the cutting edge moves with sufficient surface footage in any of a three dimensional cutting path to remove material from the workpiece.

28. A non-rotary machine tool for machining a workpiece as in claim 27, further comprising:
a bed for moving the workpiece in a first direction;
a saddle for moving the workpiece in a second direction; and
a head for moving the tool holder in a third direction.

29. A non-rotary machine tool for machining a workpiece as in claim 28, wherein the saddle moves orthogonally on top of the bed.

30. A non-rotary machine tool for machining a workpiece as in claim 28, further including: a table fixedly positioned to the saddle.

31. A non-rotary machine tool for machining a workpiece as in claim 27, further comprising: a column for supporting the head and allowing it to move in the third direction.

32. A non-rotary machine tool for machining a workpiece as in claim 27, wherein the cutting tool is operated in a three-dimensional work envelope relative to the workpiece.

33. A non-rotary machine tool for machining a workpiece as in claim 32, wherein the cutting tool is axially asymmetric in shape.

34. A non-rotary machine tool for machining a workpiece as in claim 27, wherein the bed, saddle, and head can be moved in a plurality of straight lines that are substantially parallel to one another.

35. A non-rotary machine tool for machining a workpiece as in claim 34, wherein the plurality of straight lines include at least three straight lines that are not coplanar.
